(19) United States
(12) Patent Application Publication
(10) Pub. No.: US 2022/0245645 A1
(43) Pub. Date: Aug. 4, 2022

(54) WEARABLE BIOMETRICS DEVICE

(71) Applicant: Sean GRANT, North York (CA)

(72) Inventor: Sean GRANT, North York (CA)

(21) Appl. No.: 17/248,573

(22) Filed: Jan. 29, 2021

(51) Int. Cl. G06Q 20/40; G02B 5/32; G06F 21/32

(52) U.S. Cl. CPC G06Q 20/40145; G06F 21/32; G02B 5/32

(57) ABSTRACT

A wearable biometrics device is provided. A wearable biometrics device, for executing processes based on one or more of a user's biometric identifiers comprising a transceiver coupled to a user such that the transceiver extracts the one or more biometric identifiers from the user. The transceiver is coupled to a remote server such that the one or more biometric identifiers are processed and monitored. The remote server comprising a database for storing the one or more biometric identifiers for the user and a projection apparatus coupled to the transceiver such that a projection emitted by the projection apparatus is initiated and manipulated based on the one or more biometric identifiers.

### FIELD OF THE INVENTION

The present disclosure relates to a wearable biometrics device, more specifically but not by way of limitation, a device that executes processes based on one or more of a user's biometric identifiers.

### BACKGROUND

U.S. Pat. No. 8,825,225 B1 (Stark et al.) discloses an aerial display system with floating projection screens. Shortcomings include the bulkiness of the system, an inability for communication via holographic images and biometric identifiers from the user, an inability to store and process biometric identifiers for biometric authentication and an inability to display holographic images.

U.S. Pat No. 9,288,836 B1 (Clement et al.) discloses an electronic bracelet comprising a plurality of circuits and a battery for wireless communication with a second device via a near-field communication antenna. Shortcomings include an inability for communication via holographic images and biometric identifiers from the user, an inability to store and process biometric identifiers for biometric authentication and an inability to display holographic images.

U.S. Pub. No. 2008/0160795 A1 (Chen et al.) discloses an ultra-thin flexible device suitable for attaching onto curved surfaces. Shortcomings include an inability for communication via holographic images and biometric identifiers from the user, an inability to store and process biometric identifiers for biometric authentication and an inability to display holographic images.

U.S. Pub. No. 2011/0273372 A1 (Aliaj) discloses a mobile device system having a translucent screen, holographic screen and a full size keyboard. Shortcomings include the bulkiness of the system, an inability for communication via holographic images and biometric identifiers from the user, an inability to store and process biometric identifiers for biometric authentication and an inability to display holographic images.

U.S. Pub. No. 2014/0111479 A1 (Krah et al.) discloses an interactive three-dimensional display system. Shortcomings include the bulkiness of the system, an inability for communication via holographic images and biometric identifiers from the user and an inability to store and process biometric identifiers for biometric authentication.

U.S. Pub. No. 2015/0192903 A1 (Vondle et al.) discloses a flexible wristwatch with segmented e-paper display. Shortcomings include an inability for communication via holographic images and biometric identifiers from the user, an inability to store and process biometric identifiers for biometric authentication and an inability to display holographic images.

U.S. Pub. No. 2016/0335801 A1 (Yoon et al.) discloses an electronic device and method for displaying event in virtual reality mode. Shortcomings include the bulkiness of the system, an inability for communication via holographic images and biometric identifiers from the user, an inability to store and process biometric identifiers for biometric authentication and an inability to display holographic images.

C.A. Pat. No. 2,280,022 A1 (Mann) discloses a contact lens for private display of information such as text, graphics, or pictures for the user. Shortcomings include an inability for communication via holographic images and biometric identifiers from the user and an inability to store and process biometric identifiers for biometric authentication.

C.N. Pub. No. 105,572,877 A (Chen et al.) discloses a head-mounted type augmented reality intelligent display device. Shortcomings include an inability for communication via holographic images and biometric identifiers from the user and an inability to store and process biometric identifiers for biometric authentication.

C.N. Pat. No. 203,149,296 U (Yu) discloses an intelligent watch with flexible screen. Shortcomings include an inability for communication via holographic images and biometric identifiers from the user, an inability to store and process biometric identifiers for biometric authentication and an inability to display holographic images.

C.N. Pat. No. 204,246,844 U (Xieying et al.) discloses a virtual reality type human-machine interactive holographic feedback display. Shortcomings include the bulkiness of the system, an inability for communication via holographic images and biometric identifiers from the user, an inability to store and process biometric identifiers for biometric authentication and an inability to display holographic images.

W.O. Pub. No. 2005/034070 A2 (Brown et al.) discloses a cellulose-based field of display device. Shortcomings include an inability for communication via holographic images and biometric identifiers from the user, an inability to store and process biometric identifiers for biometric authentication and an inability to display holographic images.

W.O. Pub. No. 2016/105285 A1 (Urey et al.) discloses a head-worn near-to-eye display device with variable resolution. Shortcomings include an inability for communication via holographic images and biometric identifiers from the user, an inability to store and process biometric identifiers for biometric authentication and an inability to display holographic images.

W.O. Pub. No. 2016/113427 A1 (Hansson et al.) discloses a synthetic paper and method for manufacture. Shortcomings include an inability for communication via holographic images and biometric identifiers from the user, an inability to store and process biometric identifiers for biometric authentication and an inability to display holographic images.

W.O. Pub. No. 2016/162538 A1 (Pommier et al.) discloses an electronic bracelet for displaying interactive digital content intended to be projected onto a zone of an arm. Shortcomings include an inability for communication via holographic images and biometric identifiers from the user, an inability to store and process biometric identifiers for biometric authentication and an inability to display holographic images.

All documents cited herein are incorporated by reference.

There is a need for a wearable biometrics device that executes one or more processes based on one or more of a user's biometric identifiers, extracts, stores, and monitoring one or more biometric identifiers, performs biometric authentication, provides a holographic display and is worn comfortably.

### BRIEF SUMMARY

It is the object of the present invention to provide a wearable biometrics device. A wearable biometrics device, for executing processes based on one or more of a user's biometric identifiers comprising a transceiver coupled to a user such that the transceiver extracts the one or more biometric identifiers from the user. The transceiver is coupled to a remote server such that the one or more biometric identifiers are processed and monitored. The remote server comprising a database for storing the one or more biometric identifiers for the user and a projection apparatus coupled to the transceiver such that a projection emitted by the projection apparatus is initiated and manipulated based on the one or more biometric identifiers.

In accordance with an embodiment of the invention, the one or more biometric identifiers for the user is from the group comprising DNA and neural signals.

In accordance with an embodiment of the invention, the one or more stored biometrics identifiers are crossed referenced for biometric authentication.

In accordance with an embodiment of the invention, the crosses referenced biometric identifier is the user's DNA.

In accordance with an embodiment of the invention, the biometric authentication allows for monetary transactions.

In accordance with an embodiment of the invention, the projection is a hologram.

In accordance with an embodiment of the invention, the projection apparatus is wearable on the user.

In accordance with an embodiment of the invention, the projection apparatus is powered on and off through the user blinking.

In accordance with an embodiment of the invention, the projection apparatus is worn on a surface of an eyelid of the user.

In accordance with an embodiment of the invention, the projection apparatus is worn underneath a surface of an eyelid of the user.

In accordance with an embodiment of the invention, the projection apparatus is worn on a surface of skin of the user.

In accordance with an embodiment of the invention, the transceiver is worn on a surface of skin of the user.

In accordance with an embodiment of the invention, the transceiver is a smart tattoo.

In accordance with an embodiment of the invention, the transceiver is a skin patch.

In accordance with an embodiment of the invention, the projection apparatus is worn on clothing material.

In accordance with an embodiment of the invention, the projection apparatus is powered via a liquid battery.

In accordance with an embodiment of the invention, the projection apparatus contains a substrate composed of a thin-film material.

In accordance with an embodiment of the invention, the transceiver is powered via a liquid battery.

In accordance with an embodiment of the invention, the transceiver contains a substrate composed of a thin-film material.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2A illustrates an aspect of the subject matter in accordance with one embodiment.

FIG. 2B illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5 illustrates an aspect of the subject matter in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

The present invention is a paper thin and foldable DNA based device that works on a liquefied battery connecting a wrist based device to a near field communication implanted chip that works through a virtual contact lenses that will help to produce holographic 3D or 4D images through the wrist as well as ambient mobile placement display technology to project emails, texts, internet browsers, television etc. onto the projection screen or any surface display alongside the holographic display without the need of a smart phone, television, radio or computer.

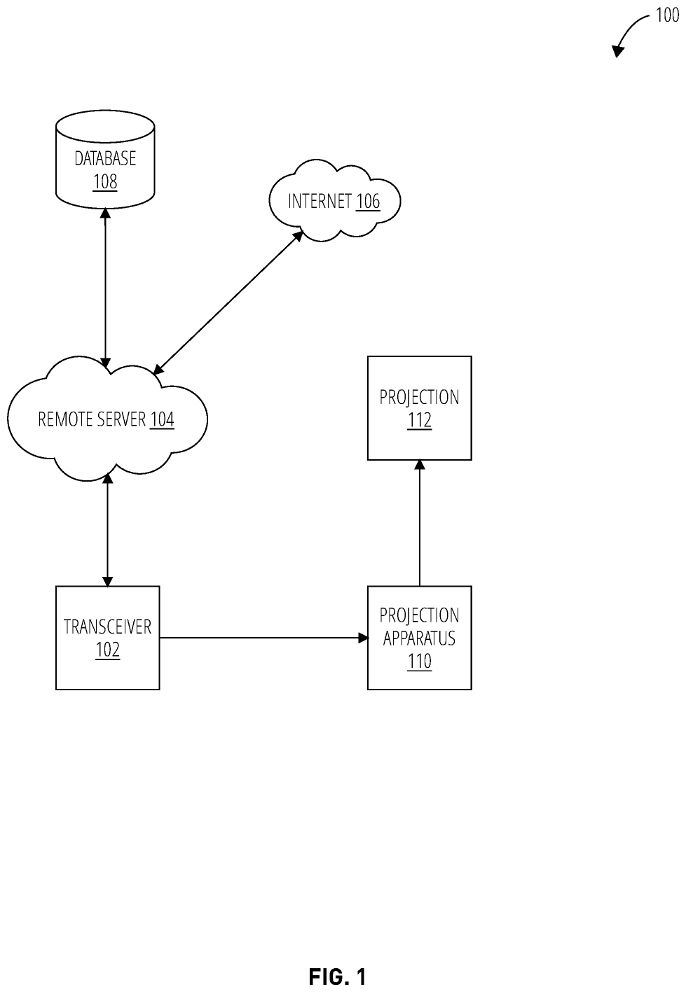

FIG. 1 depicts a high level system diagram 100 of the wearable biometrics device for executing processes based on one or more of a user's biometric identifiers as in one embodiment. This high level system diagram 100 includes a transceiver 102 that is wirelessly coupled to a remote server 104 such that the one or more biometric identifiers are processed and monitored. The remote server 104 is connected to the internet 106 and comprises a database 108 for storing the one or more biometric identifiers for the user.

Furthermore, the transceiver 102 is coupled to a user such that the transceiver 102 is able to extract the one or more biometric identifiers from the user. A projection apparatus 102 is coupled to the transceiver 102 such that a projection 112 emitted by the projection apparatus 102 is initiated and manipulated based on the one or more biometric identifiers. In some embodiments, the projection 112 is a hologram.

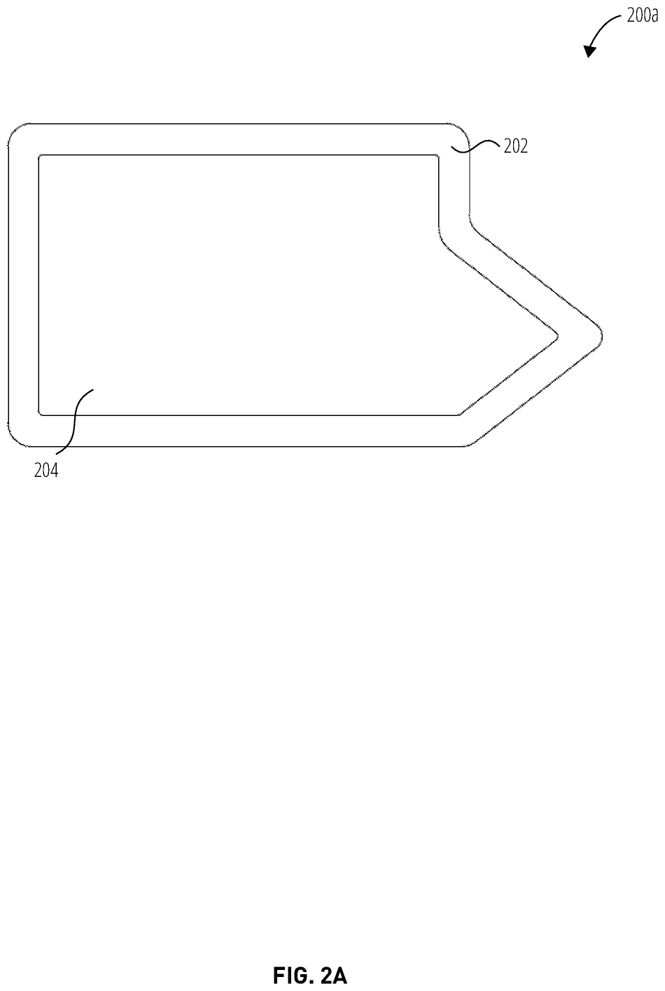

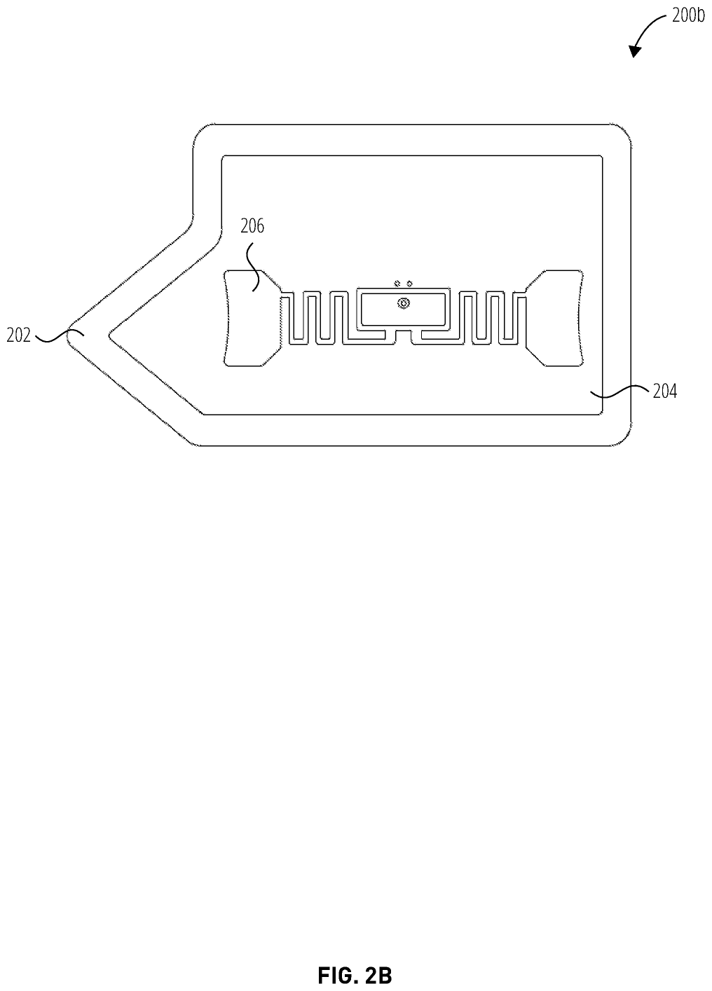

FIG. 2A depicts a front exterior view 200a of the projection apparatus 110 of a wearable biometrics device as in one embodiment. The transceiver 102 is shown with a liquified battery 202 along the perimeter which is used as a power source for the transceiver 102. An underlying substrate 204 of the transceiver 102 is shown, and in some embodiments the substrate is composed of a thin-film material. In some embodiments, the transceiver 102 is applied onto the user's skin with an adhesive as a skin patch. In some embodiments, the transceiver 102 is a smart tattoo on the user's skin.

FIG. 2B depicts a rear exterior view 200b of the projection apparatus 110 of a wearable biometrics device as in one embodiment. The transceiver 102 is shown with nano-capacitor 206 which is capable of sending and receiving electric signals, necessary in biometric identifier extraction from the user. In some embodiments, the nano-capacitor 206 is capable of extracting DNA and DNA sequences.

The one or more biometric identifiers extracted from the user typically comprise DNA sequences and neural signals. In some embodiments, one or more of the stored biometrics identifiers are crossed referenced for biometric authentication. In some embodiments, the cross referenced biometric identifier is the user's DNA. The biometric authentication allows for monetary transactions and provides an alternative method for virtual transaction strictly through the wearable biometrics device.

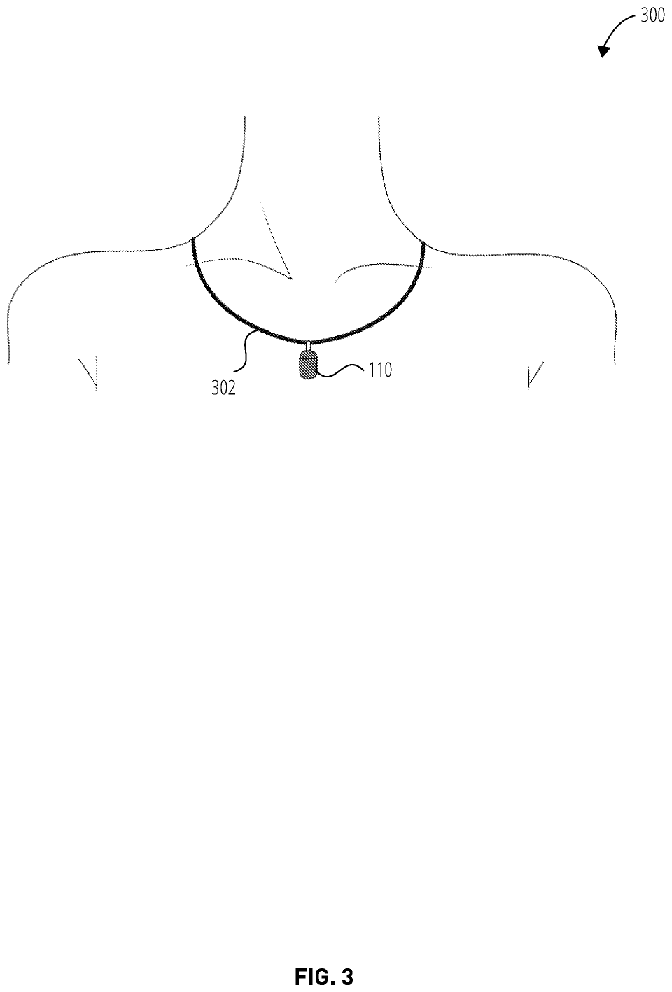

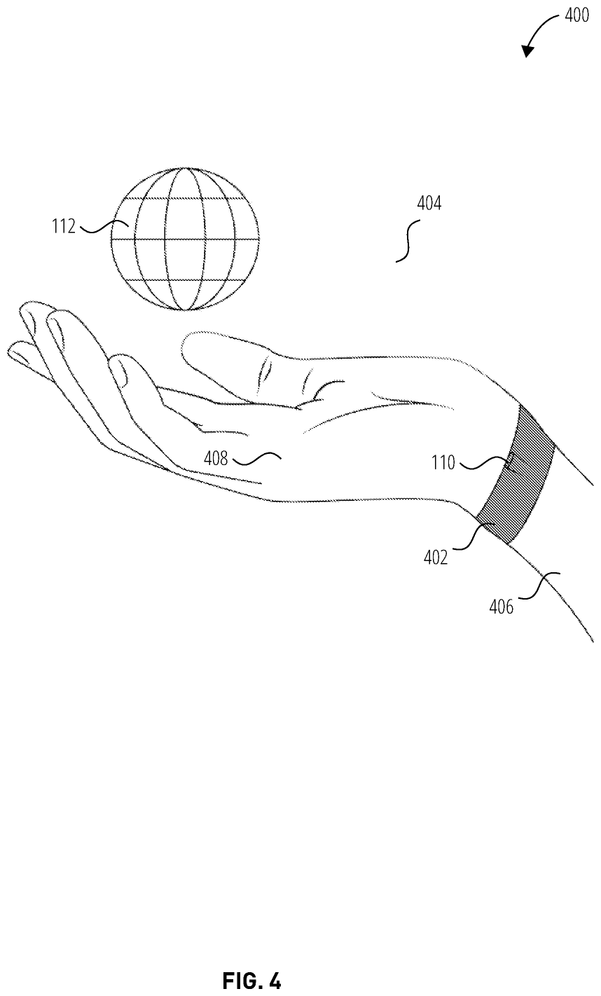

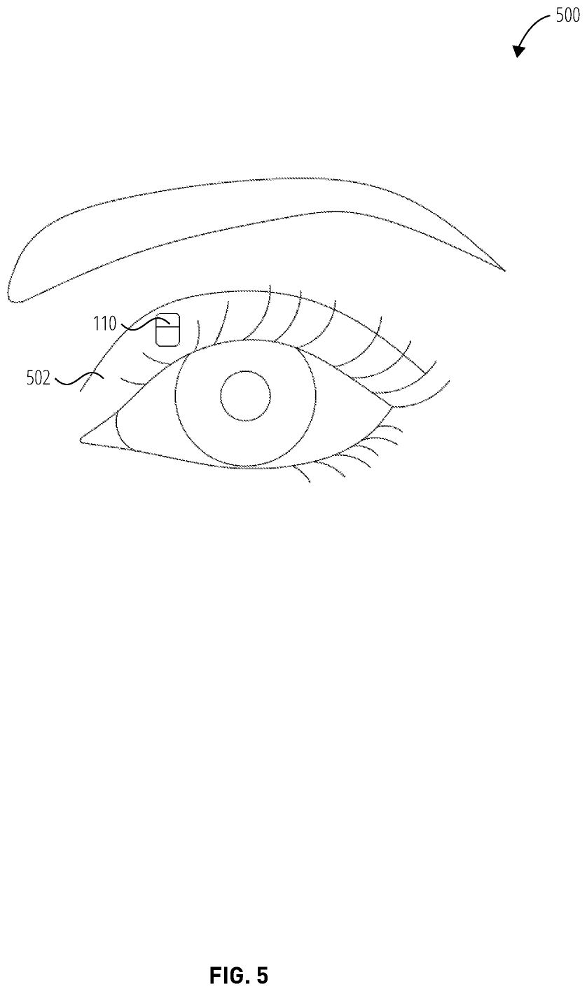

The biometric identifiers are the distinctive, measurable characteristics that are unique to each individual user and far more reliable in verifying identity than currently employed methods. Examples of biometric identifiers include, but are not limited to neural signals, fingerprints, DNA, and iris recognition. The biometric identifiers are captured by the transceiver 102 and sent to a remote server 104 for processing and storage. The biometric identifiers that are stored in the database 108 may be shared for future biometric authentication for applications such as, but not limited to, purchasing and banking transactions. The biometric identifiers may also be employed for navigation of applications in connection with the internet 106, to control the output projection as well as various tasks within the applications. In some embodiments, the transceiver 102 is worn on the surface of the user's skin in the form of jewelry or any other decorative or personal ornaments such as shown in FIG. 3, FIG. 4 and FIG. 5. In some embodiments, the projection apparatus 110 is wearable on the user such as shown in FIG. 3, FIG. 4 and FIG. 5. In other embodiments, the projection apparatus 110 is worn on the surface of the user's skin. In other embodiments, the projection apparatus 110 is worn on clothing material.

FIG. 3 depicts a necklace application 300 of the wearable biometrics device as in one embodiment. The example displays a comfortable employment of the transceiver 102 attached to a necklace 302. The transceiver 102 extracts the biometric identifiers from the user's neck and transmits this information to the remote server 104 and a projection apparatus 110 not currently shown.

FIG. 4 depicts a wristband application 400 of the wearable biometrics device as in one embodiment. In this example, the transceiver 102, not currently shown, sends input to the projection apparatus 110. The projection apparatus 110 is affixed to a wristband 402, comfortably worn on a user's wrist 406. The projection apparatus 110 emits a projection 112 within a projection media 404 above the user's palm 408.

FIG. 5 depicts an eyelid application 500 of the wearable biometrics device as in one embodiment. In this embodiment, the projection apparatus 110 is worn on the surface of the user's eyelid 502. In some embodiments, the projection apparatus 110 is worn underneath a surface of the user's eyelid 502 such that it isn't visible to others. In some embodiments, the projection apparatus 110 is attached via an adhesive. The projection apparatus 110 emits a projection 112 in front of the user's face to allow for a comfortable and convenient display.

In some embodiments, the projection apparatus 110 is powered on and off through the user blinking. In some embodiments, the projection apparatus 110 contains a substrate composed of a thin-film material. In some embodiments, the projection apparatus 110 is powered via a liquid battery.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

What is claimed is:

1. A wearable biometrics device, for executing processes based on one or more of a user's biometric identifiers comprising:
a transceiver coupled to a user such that said transceiver extracts said one or more biometric identifiers from said user;
said transceiver is coupled to a remote server such that said one or more biometric identifiers are processed and monitored;
said remote server comprising a database for storing said one or more biometric identifiers for said user; and
a projection apparatus coupled to said transceiver such that a projection emitted by said projection apparatus is initiated and manipulated based on said one or more biometric identifiers.

2. The wearable biometrics device of claim 1, wherein said one or more biometric identifiers for said user is from the group comprising DNA and neural signals.

3. The wearable biometrics device of claim 1, wherein said one or more stored biometrics identifiers are crossed referenced for biometric authentication.

4. The wearable biometrics device claim 3, wherein said crosses referenced biometric identifier is said user's DNA.

5. The wearable biometrics device of claim 3, where said biometric authentication allows for monetary transactions.

6. The wearable biometrics device of claim 1, wherein said projection is a hologram.

7. The wearable biometrics device of claim 1, wherein said projection apparatus is wearable on said user.

8. The wearable biometrics device of claim 1, wherein said projection apparatus is powered on and off through said user blinking.

9. The wearable biometrics device of claim 1, wherein said projection apparatus is worn on a surface of an eyelid of said user.

10. The wearable biometrics device of claim 1, wherein said projection apparatus is worn underneath a surface of an eyelid of said user.

11. The wearable biometrics device of claim 1, wherein said projection apparatus is worn on a surface of skin of said user.

12. The wearable biometrics device of claim 1, wherein said transceiver is worn on a surface of skin of said user.

13. The wearable biometrics device of claim 1, wherein said transceiver is a smart tattoo.

14. The wearable biometrics device of claim 1, wherein said transceiver is a skin patch.

15. The wearable biometrics device of claim 1, wherein said projection apparatus is worn on clothing material.

16. The wearable biometrics device of claim 1, wherein said projection apparatus is powered via a liquid battery.

17. The wearable biometrics device of claim 1, wherein said projection apparatus contains a substrate composed of a thin-film material.

18. The wearable biometrics device of claim 1, wherein said transceiver is powered via a liquid battery.

19. The wearable biometrics device of claim 1, wherein said transceiver contains a substrate composed of a thin-film material.
